(19) United States
(12) Patent Application Publication
(10) Pub. No.: US 2026/0027823 A1
(43) Pub. Date: Jan. 29, 2026

(54) PRINTING DEVICE AND PRINTING METHOD

(71) Applicant: SEIKO EPSON CORPORATION, Tokyo (JP)

(72) Inventor: Takamitsu KONDO, AZUMINO-SHI (JP)

(21) Appl. No.: 19/276,232

(22) Filed: Jul. 22, 2025

(30) Foreign Application Priority Data
Jul. 23, 2024 (JP) 2024-117545

(51) Int. Cl. B41J 2/045; B41J 2/14; B41J 2/21

(52) U.S. Cl. CPC B41J 2/04595; B41J 2/14; B41J 2/21

(57) ABSTRACT

A printing device 1 includes a head unit U including a nozzle array M of a plurality of nozzles N configured to eject liquid onto a medium S, and a control unit 4 that forms an image on the medium S by controlling an ejection operation of the head unit U. When the medium S is a fabric having glossiness and having an indentations-protrusions shape in which fibers in different directions intersect each other and liquid is pigment ink containing a pigment as a coloring material, the control unit 4 arranges the ejection region a in which liquid is ejected and the non-ejection region b in which liquid is not ejected in the gloss designation region 81a that is a region of the print image 80 that designated to leave glossiness.

The present application is based on, and claims priority from JP Application Serial Number 2024-117545, filed Jul. 23, 2024, the disclosure of which is hereby incorporated by reference herein in its entirety.

### BACKGROUND

### 1. Technical Field

The present disclosure relates to a printing device and a printing method.

### 2. Related Art

JP-A-2024-030291 discloses an inkjet recording method for forming an image on a fabric made of synthetic fibers by ejecting pigment ink onto the fabric using an inkjet method.

When an image is formed on a fabric by ejecting pigment ink onto a fabric having glossiness, a pigment needs to be aggregated in the vicinity of a surface of a fabric in order to exhibit color development. Therefore, there is a problem that glossiness of a fabric itself is lost in a region where pigment ink was ejected.

### SUMMARY

A printing device including
a print head unit including a nozzle group of a plurality of nozzles configured to eject liquid onto a medium and
a control section that forms an image on the medium by controlling an ejection operation of the print head unit, wherein
the control section is configured to execute a first print mode in which, when the medium is a fabric having glossiness and having an indentations-protrusions shape in which fibers in different directions intersect each other, and the liquid is pigment ink containing a pigment as a coloring material, an ejection region in which the liquid is ejected and a non-ejection region in which the liquid is not ejected are arranged in a gloss designation region that is a region of an input image that designated to leave glossiness is provided.

A printing method of forming an image on a medium by controlling an ejection operation of a print head unit including a nozzle group of a plurality of nozzles configured to eject liquid onto the medium, the printing method including
executing a first print mode, by a computer, in which, when the medium is a fabric having glossiness and having an indentations-protrusions shape in which fibers in different directions intersect each other, and the liquid is pigment ink containing a pigment as a coloring material, an ejection region in which the liquid is ejected and a non-ejection region in which the liquid is not ejected are arranged in a gloss designation region that is a region of an input image that designated to leave glossiness is provided.

### BRIEF DESCRIPTION OF THE DRAWINGS

FIG. 1 is a configuration schematic diagram of a printing device.

FIG. 2 is a control flow of the printing device.

FIG. 3 is a control flow of the printing device.

FIG. 4 is an example of a print image.

FIG. 5 is an example of a warning screen.

FIG. 6 is an example of a gloss designation image.

FIG. 7 is an example of a glossy print setting screen.

FIG. 8 is a specific example of a tile.

FIG. 9 is an example of a mask.

FIG. 10 is a print image to which the mask is applied.

FIG. 11 is a modification of the tile.

### DESCRIPTION OF EMBODIMENTS

Hereinafter, the present disclosure will be described through embodiments of the disclosure, but the disclosure according to the claims is not limited to the following embodiments. In addition, all of the configurations described in the embodiments are not necessarily essential as units for solving the problem. For clarification of the description, the following description and the drawings are omitted and simplified as appropriate. In the drawings, the same elements are denoted by the same reference symbols, and redundant description is omitted as necessary.

In each drawing, X, Y, and Z represent three spatial axes orthogonal to each other. In the present specification, directions along these axes are referred to as an X direction, a Y direction, and a Z direction. In the following description, a direction of an arrow in each drawing is defined as a positive (+) direction, and a direction opposite to the arrow is defined as a negative (−) direction. Directions of three spatial axes that do not limit the positive direction and the negative direction are described as an X-axis direction, a Y-axis direction, and a Z-axis direction.

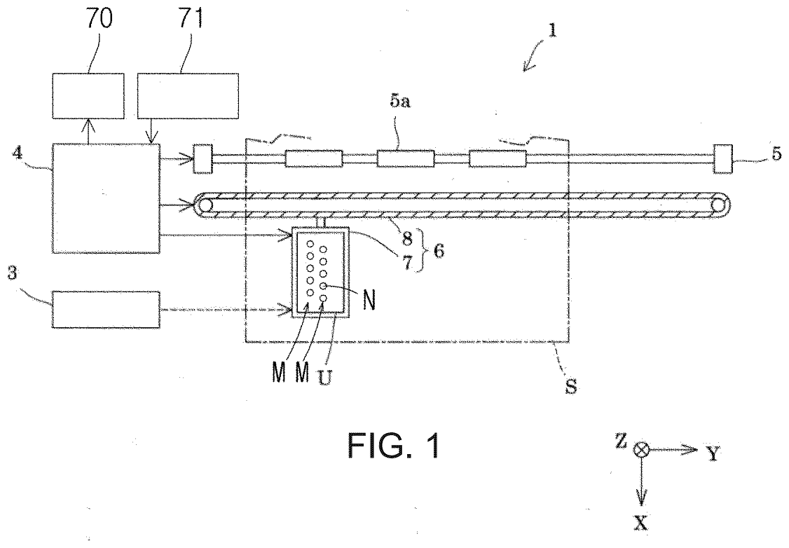

As shown in FIG. 1, a printing device 1 is a so-called serial type digital textile printing machine that includes a head unit U including a plurality of nozzle arrays M each including a plurality of nozzles N, and performs printing by ejecting liquid from the plurality of nozzles N toward a medium S in a +Z direction while transporting the medium S in the X-axis direction and reciprocating the head unit U in the Y-axis direction. The head unit U is a specific example of a print head unit. Note that any material such as a fabric, a recording sheet, or a resin film can be used as the medium S. The fabric is not particularly limited. The material constituting the fabric is not particularly limited, and examples thereof include natural fibers such as cotton, linen, wool, and silk, synthetic fibers such as polypropylene, polyester, acetate, triacetate, polyamide, and polyurethane, biodegradable fibers such as polylactic acid, and the like, and may be blended fibers thereof. The fabric may be any form of the above-described fibers such as a woven fabric, a knitted fabric, and a nonwoven fabric, or may be a mixed fabric or the like. Examples of liquid ejected by the printing device 1 include pigment ink containing a pigment as a coloring material, reaction liquid containing a flocculant for flocculating pigment ink, treatment liquid containing a softener, and overcoat liquid. Pigment ink is a specific example of liquid.

Pigment ink contains at least a pigment and water. Examples of a pigment contained in pigment ink include color pigments such as cyan, yellow, magenta, and black, and special color pigments such as white and pearl. The pigments may be mixtures. The pigment is excellent in storage stability such as light resistance, weather resistance, and gas resistance, and from this viewpoint, an organic pigment is desirable. Specifically, as a pigment, azo pigments such as insoluble azo pigments, condensed azo pigments, azo lakes, and chelated azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelates, dye lakes, nitro pigments, nitroso pigments, aniline black, daylight fluorescent pigments, carbon black, and the like are used. The pigments may be used alone or in combination of two or more kinds thereof. Further, as a pigment, a white pigment, a photoluminescent pigment, or the like may be used.

The printing device 1 includes the head unit U, a liquid storage section 3, a control unit 4 that is a control section, a transport mechanism 5 that feeds the medium S, a movement mechanism 6, a display 70, and a touch screen 71. The display 70 is a specific example of a display unit. The touch screen 71 is a specific example of an input unit. The display 70 and the touch screen 71 are typically arranged in an overlapping manner. The control unit 4 includes, for example, a control device such as a central processing unit (CPU) or a field programmable gate array (FPGA), and a storage device such as a semiconductor memory. The control unit 4 is electrically connected to the head unit U via an external wiring (not shown). The control unit 4 generally controls each element of the printing device 1, that is, the head unit U, the transport mechanism 5, the movement mechanism 6, and the like, in accordance with print image data typically acquired from an external device such as a personal computer.

The transport mechanism 5 transports the medium S in the X-axis direction and includes a transport roller 5a. That is, the transport mechanism 5 transports the medium S in the X-axis direction by the transport roller 5a rotating. The transport roller 5a is rotated by driving of a transport motor (not shown). The control unit 4 controls the transport of the medium S by controlling the driving of the medium transport motor.

The movement mechanism 6 is a mechanism for reciprocating the head unit U in the Y-axis direction, and includes a holding body 7 and a transport belt 8. The holding body 7 is a so-called carriage that holds the head unit U, and is fixed to the transport belt 8. The transport belt 8 is an endless belt installed along the Y-axis direction. The transport belt 8 is rotated by driving of a transport motor (not shown). The control unit 4 rotates the transport belt 8 by controlling the driving of the transport motor, and reciprocates the head unit U in the Y-axis direction together with the holding body 7.

The head unit U executes an ejection operation of ejecting liquid supplied from the liquid storage section 3 as droplets in the +Z direction from each of the plurality of nozzles N under the control of the control unit 4. The ejection operation by the head unit U is performed in parallel with the transport of the medium S by the transport mechanism 5 and the reciprocating movement of the head unit U by the movement mechanism 6, and thus, so-called printing in which liquid is applied to the medium S and an image is formed on the medium S is performed.

There are two types of printing processing methods, namely, a bidirectional printing method and a unidirectional printing method. Hereinafter, moving the head unit U once in the Y-axis direction is referred to as one pass. A period of one pass is a period required for moving the head unit U once in the Y-axis direction.

In the bidirectional printing method, the printing device 1 executes a +Y direction printing process of ejecting liquid while moving the head unit U in the +Y direction to form a partial image corresponding to a bandwidth corresponding to a first pass on the medium S. Next, the printing device 1 executes a moving process of moving the medium S in the X-axis direction corresponding to a bandwidth, and executes a-Y direction printing process of ejecting liquid while moving the head unit U in the −Y direction to form a partial image corresponding to a bandwidth corresponding to a second pass on the medium S. Thereafter, the printing device 1 repeats the +Y direction printing process and the −Y direction printing process until an image is formed on the medium S.

In the unidirectional printing method, the +Y direction printing process described above is executed. Next, the printing device 1 executes a moving process of moving the medium S in the X-axis direction corresponding to a bandwidth. Thereafter, the printing device 1 repeats the +Y direction printing process and the moving process until an image is formed on the medium S.

The control unit 4 can selectively execute a normal print mode and a glossy print mode. The glossy print mode is a specific example of a first print mode.

When the normal print mode is executed, the control unit 4 forms an image on the medium S by ejecting pigment ink onto the medium S in accordance with print image data.

In contrast, when the glossy print mode is executed, the control unit 4 performs a masking process on print image data, and forms an image on the medium S by ejecting pigment ink onto the medium S in accordance with print image data after the masking process. Specifically, the control unit 4 alternately arranges an ejection region where pigment ink is ejected and a non-ejection region where pigment ink is not ejected in a gloss designation region that is a region designated to leave glossiness in an print image indicated by print image data by the masking process. By this, the medium S is exposed in places in the gloss designation region, and thus it is possible to leave glossiness of the medium S itself to some extent while exhibiting color of the gloss designation region.

Therefore, when the control unit 4 executes the glossy print mode, the medium S is limited to a fabric having glossiness and having an indentations-protrusions shape in which fibers in different directions intersect each other. A fabric having an indentations-protrusions shape in which fibers in different directions intersect each other includes a fabric having an indentations-protrusions shape in which a plurality of fibers intersect with each other. In other words, the phrase “having an indentations-protrusions shape in which fibers in different directions intersect each other” means that a fabric is not a nonwoven fabric but a woven fabric or a knitted fabric. A fabric having glossiness typically means that reflection characteristics of light change depending on an angle at which the fabric is observed. For example, if a fabric is wrinkled such that the fabric is wavy, peaks of waves will typically appear white if the lighting in the viewing environment is white. In this case, a fabric is said to have glossiness. As an example of a fabric having glossiness, a fabric woven with chemical fibers is exemplified. This is because chemical fibers exhibit a flat surface texture as compared with natural fibers. Examples of chemical fibers include synthetic fibers such as polypropylene, polyester, acetate, triacetate, polyamide, and polyurethane, as described above. Examples of a fabric having glossiness include a fabric woven by twill weave or satin weave. This is because a fabric woven by twill weave or satin weave exhibits glossiness due to the appearance of a large amount of warp threads on a surface as compared with a fabric woven by plain weave.

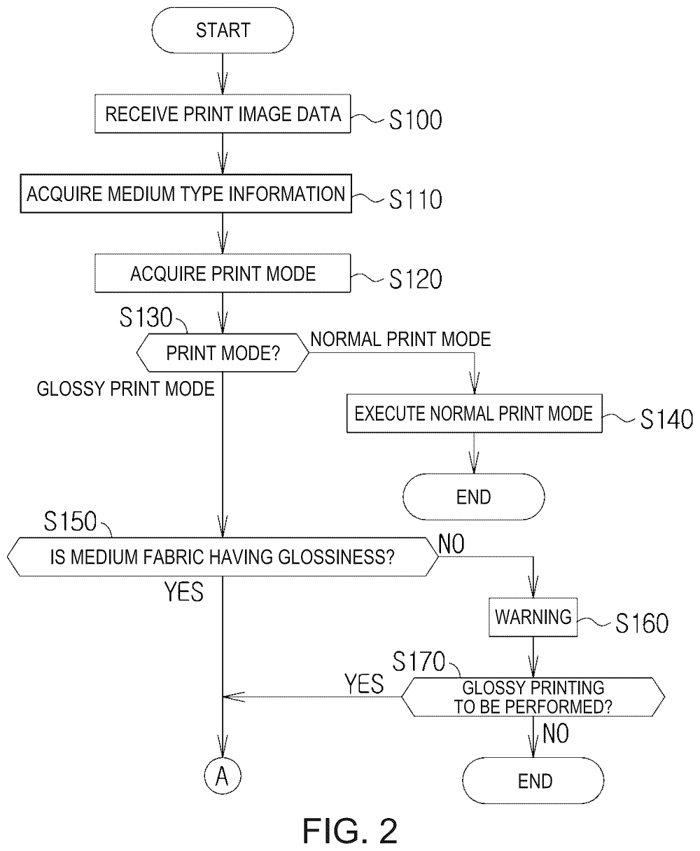

Next, an operation flow of the printing device 1 will be described in detail with reference to FIGS. 2 to 10.

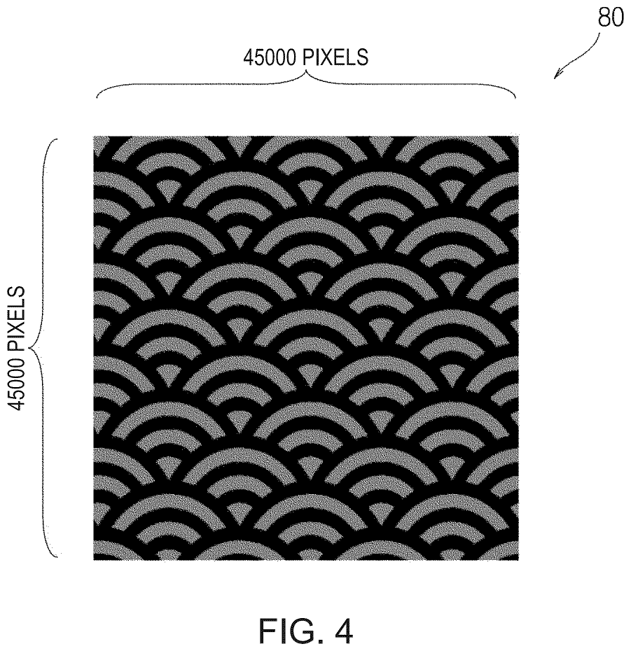

First, the control unit 4 receives print image data (S100). Print image data is typically data representing a print image 80 shown in FIG. 4, which is created by a user using an application installed in a personal computer. The print image 80 is an image representing a pattern or a design. The print image 80 is also referred to as an input image. The print image 80 shown in FIG. 4 has a size of 45000 pixels in width and 45000 pixels in height, as an example. The print image 80 shown in FIG. 4 is a grayscale image, as an example. However, the print image 80 may be a color image.

Next, the control unit 4 acquires medium type information indicating the type of medium S input by a user via the touch screen 71 (S110).

Next, the control unit 4 displays a screen for selecting either a normal print mode or a glossy print mode as a print mode on the display 70, and acquires a print mode selected by a user via the touch screen 71 (S120).

Next, in step S130, when the print mode acquired in step S120 is the normal print mode, the control unit 4 executes the normal print mode (S140) to form the print image 80 indicated by the print image data on the medium S, and ends the process.

On the other hand, in step S130, when the print mode acquired in step S120 is the glossy print mode, the control unit 4 determines whether or not the medium S on which the print image 80 is formed in the glossy print mode is a fabric having glossiness based on the medium type information of the medium S acquired in step S110 (S150). When the medium S is not a fabric having glossiness (S150: NO), the control unit 4 advances the process to step S160. On the other hand, when the medium S is a fabric having glossiness (S150: YES), the control unit 4 advances the process to step S200.

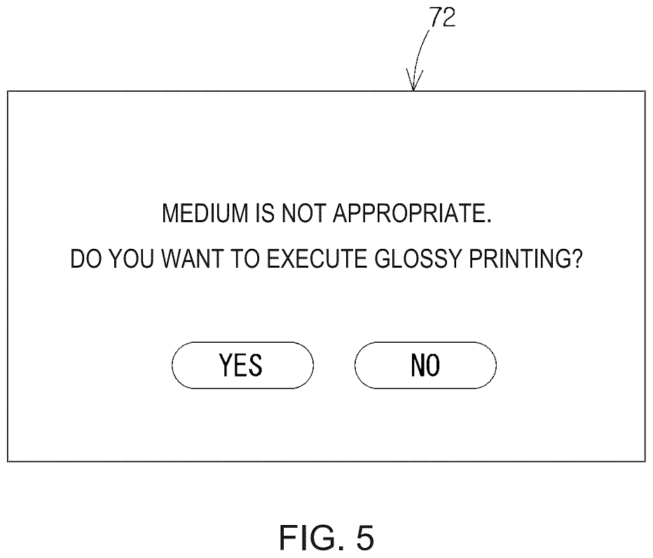

In step S160, the control unit 4 displays a warning screen 72 shown in FIG. 5 on the display 70. That is, the glossy print mode is based on the premise that the medium S is a fabric having glossiness. This is because, in a case where the medium S is not a fabric having glossiness, a visual effect specific to the glossy print mode in which both color and gloss are achieved with pigment ink is not exhibited. Therefore, as shown in FIG. 5, the warning screen 72 indicates that the medium S is not suitable for the glossy print mode and asks a user whether or not to execute the glossy print mode. Then, in step S170, when a user selects to execute the glossy print mode (S170: YES), the control unit 4 advances the process to step S200. On the other hand, when a user selects not to execute the glossy print mode in step S170 (S170: NO), the control unit 4 ends the process.

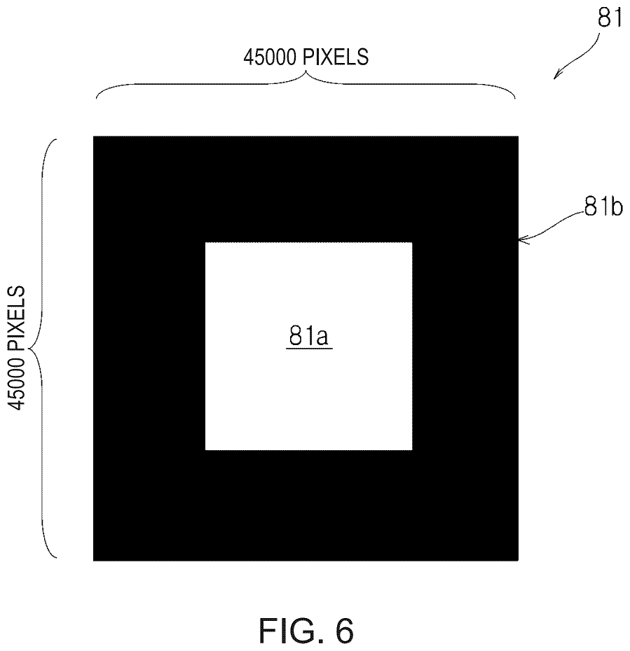

In step S200, the control unit 4 receives gloss designation data (S200). The gloss designation data is typically data indicating a gloss designation image 81 shown in FIG. 6, which is created by a user using an application installed in a personal computer. The gloss designation image 81 shown in FIG. 6 typically has the same size as the print image 80. That is, in the present embodiment, the gloss designation image 81 has a size of 45000 pixels in width and 45000 pixels in height. In the gloss designation image 81 shown in FIG. 6, a white region is a gloss designation region 81a, and a black region is a gloss non-designation region 81b.

The gloss designation region 81a is a region of the print image 80 designated to leave glossiness. In other words, the gloss designation region 81a is a region of the print image 80 designated so that glossiness is prioritized over color development. The gloss non-designation region 81b is a region of the print image 80 designated to place importance on color development. In other words, the gloss non-designation region 81b is a region of the print image 80 designated so that color development is prioritized over glossiness.

The gloss designation region 81a and the gloss non-designation region 81b are in a complementary relationship with each other. That is, in the gloss designation image 81, a portion excluding the gloss designation region 81a corresponds to the gloss non-designation region 81b. In the present embodiment, as an example, the gloss non-designation region 81b is designated so as to surround the gloss designation region 81a.

A method of designating the gloss designation region 81a and the gloss non-designation region 81b in the print image 80 is not limited to two color image shown in FIG. 6. For example, when the gloss designation region 81a is rectangular, the gloss designation region 81a may be designated by upper left coordinates and lower right coordinates of the gloss designation region 81a. For example, when the gloss designation region 81a is circular, the gloss designation region 81a may be designated by center coordinates and the radius of the gloss designation region 81a. The gloss designation image 81 in which the gloss designation region 81a is red and the gloss non-designation region 81b is blue is also conceivable.

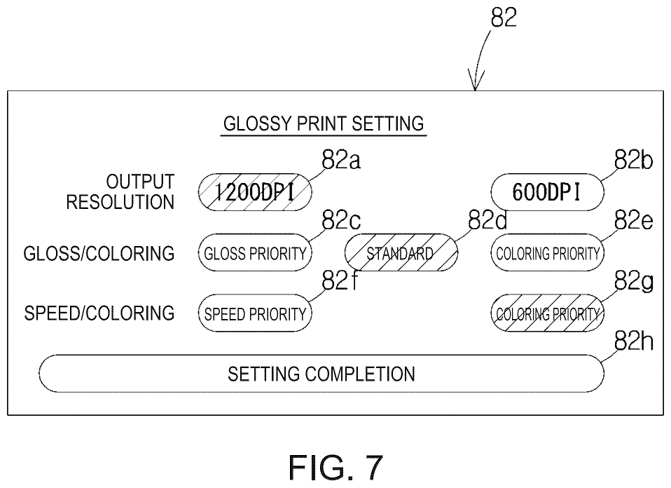

Next, the control unit 4 outputs a glossy print setting screen 82 shown in FIG. 7 to the display 70. The glossy print setting screen 82 is configured to allow a user to input, via the touch screen 71, the output resolution of a print image, which of glossiness and color development is prioritized, and which of print speed and color development is prioritized, as an example.

Specifically, on the glossy print setting screen 82, a radio button 82a for an image format labeled “1200 DPI” and a radio button 82b for an image format labeled “600 DPI” are arranged. A user alternatively selects one of the radio button 82a and the radio button 82b via the touch screen 71. Similarly, a radio button 82c for an image format labeled “GLOSS PRIORITY”, a radio button 82d for an image format labeled “STANDARD”, and a radio button 82e for an image format labeled “COLORING PRIORITY” are arranged on the glossy print setting screen 82. A user alternatively selects any one of the radio button 82c, the radio button 82d, and the radio button 82e via the touch screen 71. Similarly, a radio button 82f for an image format labeled “SPEED PRIORITY” and a radio button 82g for an image format labeled “COLORING PRIORITY” are arranged on the glossy print setting screen 82. A user alternatively selects one of the radio button 82f and the radio button 82g via the touch screen 71.

A setting completion button 82h is arranged on the glossy print setting screen 82. When a user finishes inputting the output resolution of the print image, which of glossiness and color development is prioritized, and which of print speed and color development is prioritized on the glossy print setting screen 82 via the touch screen 71, the user taps a setting completion button 82h. In response to the tap of the setting completion button 82h, the control unit 4 acquires the output resolution of the print image (S210), acquires which of glossiness and color development is prioritized (S220), and acquires which of print speed and color development is prioritized (S230).

Next, the control unit 4 selects a tile for generating a mask to be applied to the print image 80 (S240).

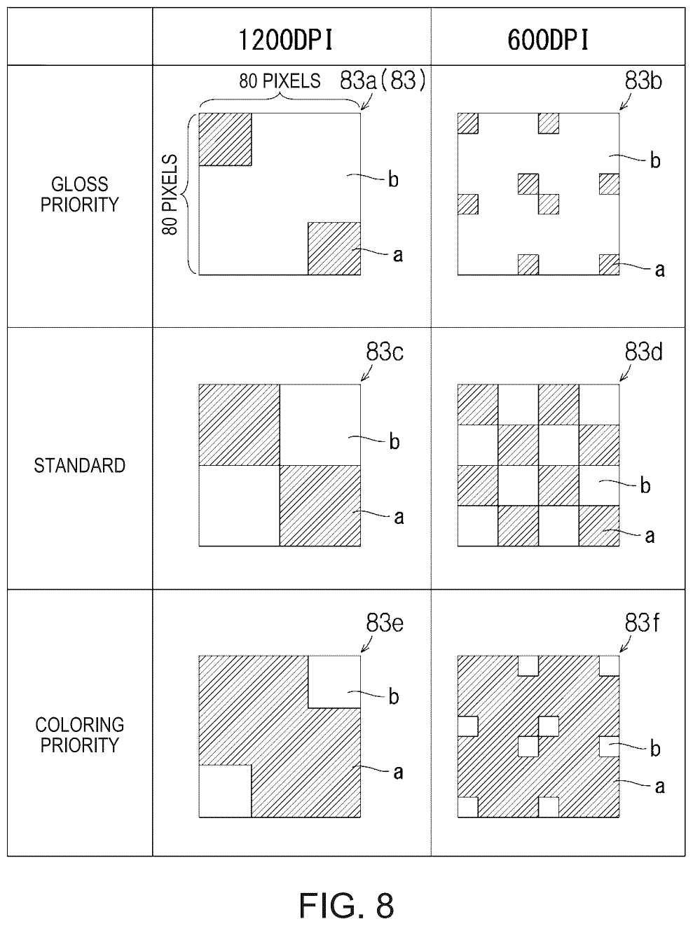

In the present embodiment, a region corresponding to the gloss designation region 81a in a mask includes a tiling pattern in which single tiles are repeatedly laid in a predetermined direction, and defines an ejection region a and a non-ejection region b. A tile is typically a unit pattern that repeats in a tiling pattern, for example, a rectangular two color image. FIG. 8 shows a plurality of types of tiles 83. A storage device of the control unit 4 stores tile data indicating the plurality of types of tiles 83 shown in FIG. 8 in advance. In the present embodiment, the plurality of types of tiles 83 include a tile 83a, a tile 83b, a tile 83c, a tile 83d, a tile 83e, and a tile 83f. Each tile 83 has a size of 80 pixels in width and 80 pixels in height, for example. In the present embodiment, each tile 83 is a black-and-white image. Each tile 83 defines at least one ejection region a and at least one non-ejection region b. The ejection region a is a region where pigment ink is ejected. The non-ejection region b is a region where pigment ink is not ejected. As an example, each tile 83 has a lattice pattern. More specifically, each tile 83 has a checkered pattern, which is a type of a lattice pattern.

In FIG. 8, as an example, the two color image is a black-and-white image, a black region is the ejection region a, and a white region is the non-ejection region b. However, instead of this, the two color image may be formed of, for example, cyan and magenta. In this case, it is conceivable that one of a cyan color region and a magenta color region is set as the ejection region a and the other is set as the non-ejection region b.

The tile 83a, the tile 83c, and the tile 83e are tiles used when the output resolution of the print image is set to 1200 DPI. On the other hand, the tile 83b, the tile 83d, and the tile 83f are tiles used when the output resolution of the print image is set to 600 DPI. The number of vertical pixels and the number of horizontal pixels of one ejection region a included in the tile 83a are twice the number of vertical pixels and the number of horizontal pixels of one ejection region a included in the tile 83b. The number of vertical pixels and the number of horizontal pixels of one ejection region a included in the tile 83c are twice the number of vertical pixels and the number of horizontal pixels of one ejection region a included in the tile 83d. The number of vertical pixels and the number of horizontal pixels of one ejection region a included in the tile 83e are twice the number of vertical pixels and the number of horizontal pixels of one ejection region a included in the tile 83f.

By using the tiles 83 in accordance with the output resolution of the print image in this manner, it is possible to secure the outer dimension of the non-ejection region b in a print product to be equal to or larger than the predetermined outer dimension. The outer dimension of the non-ejection region b in a print product is typically 0.3 mm or more and less than 3 mm, desirably 0.5 mm or more and less than 1 mm, and more desirably 0.7 mm or more and less than 0.9 mm.

The tile 83a and the tile 83b are tiles used when glossiness is prioritized over color development. Therefore, in the tile 83a and the tile 83b, the total area of the non-ejection regions b is larger than the total area of the ejection regions a. In the tile 83a and the tile 83b, the area ratio of the ejection region a and the non-ejection region b is 2:7. The tile 83e and the tile 83f are tiles used when color development is prioritized over glossiness. Therefore, in the tile 83e and the tile 83f, the total area of the ejection regions a is larger than the total area of the non-ejection regions b. In the tile 83e and the tile 83f, the area ratio of the ejection region a and the non-ejection region b is 7:2. The tile 83c and the tile 83d are tiles used when there is no need to consider superiority or inferiority in glossiness and color development. Therefore, in the tile 83c and the tile 83d, the total area of the ejection regions a and the total area of the non-ejection regions b are equal to each other. In the tile 83c and the tile 83d, the area ratio of the ejection region a and the non-ejection region b is 1:1. As described above, the control unit 4 includes the plurality of types of tiles 83 having different area ratios of the ejection region a and the non-ejection region b for a masking process.

Therefore, the control unit 4 selects one tile 83 from the plurality of types of tiles 83 shown in FIG. 8 based on the output resolution of the print image acquired in step S210 and which of glossiness and color development acquired in step S220 is prioritized (S240). For example, as shown in FIG. 7, when the output resolution of the print image is set to 1200 DPI and glossiness and color development are set to be equal, the control unit 4 selects the tile 83c from the plurality of types of tiles 83.

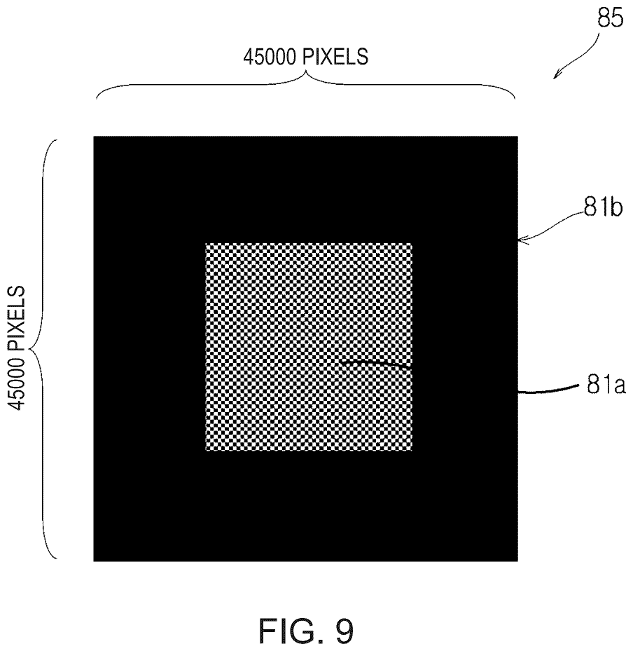

Next, the control unit 4 generates a mask 85 shown in FIG. 9 using the gloss designation image 81 acquired in step S200 and the tile 83 selected in step S240 (S250). The mask 85 shown in FIG. 9 typically has the same size as the print image 80 and the gloss designation image 81. That is, in the present embodiment, the mask 85 has a size of 45000 pixels in width and 45000 pixels in height. The control unit 4 generates the mask 85 shown in FIG. 9 by laying the tiles 83 selected in the step S240 in the gloss designation region 81a of the gloss designation image 81 shown in FIG. 6 without gaps in the vertical and horizontal directions. In the mask 85, the gloss non-designation region 81b and pixels corresponding to the ejection region a in the gloss designation region 81a are black, and the other pixels, that is, pixels corresponding to the non-ejection region b in the gloss designation region 81a are white. The black pixels in the mask 85 are pixels that allow pigment ink to be ejected. In contrast, the white pixels in the mask 85 are pixels where ejection of pigment ink is prohibited.

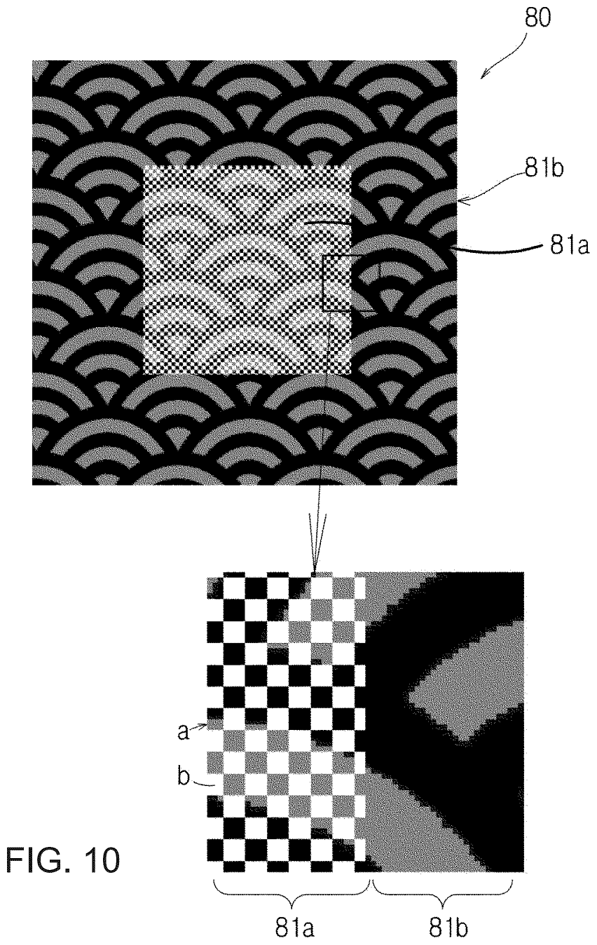

Next, the control unit 4 applies the mask 85 generated in step S250 to the print image 80 (S260). Specifically, the control unit 4 maintains color information (RGB value, CMYK value, alpha value) of pixels corresponding to black pixels in the mask 85 in the print image 80, and changes color information of pixels corresponding to white pixels in the mask 85 in the print image 80 to white or a completely transparent color. FIG. 10 shows the print image 80 to which the mask 85 is applied. As shown in FIG. 10, in the gloss designation region 81a of the print image 80, the ejection region a and the non-ejection region b are alternately arranged in a horizontal direction and a vertical direction, and as a result, the print image 80 is thinned out in the gloss designation region 81a. In contrast, in the gloss non-designation region 81b of the print image 80, the print image 80 is not thinned out at all, and color information at the stage of being acquired in step S100 is maintained as it is in all the pixels. By this, in the gloss designation region 81a, the print image 80 is thinned out in places due to the presence of a large number of non-ejection regions b, and thus the medium S are exposed in places without being covered with pigment ink. As a result, in the gloss designation region 81a of a print product, color development of a pattern expressed by the print image 80 is ensured to a certain extent by the presence of the large number of ejection regions a, and glossiness of the pattern is simultaneously realized by the presence of the large number of non-ejection regions b that coexist.

Next, the control unit 4 adjusts the input level of the print image 80 to which the mask 85 is applied (S270). In detail, the control unit 4 intentionally lowers color development of the gloss non-designation region 81b by lowering the input level of the gloss non-designation region 81b in the print image 80. Here, lowering the input level means increasing the RGB value of the corresponding pixel, decreasing the CMYK value of the corresponding pixel to make the pixel closer to white, or decreasing the alpha value of the corresponding pixel to make the pixel closer to transparent. That is, since color development is lost in the gloss designation region 81a due to the presence of a large number of non-ejection regions b as compared with color development before a mask is applied, color development in the gloss designation region 81a is lower than color development in the gloss non-designation region 81b. Therefore, by intentionally lowering color development of the gloss non-designation region 81b, the color development of the gloss designation region 81a and the color development of the gloss non-designation region 81b can be made close to each other.

Next, when color information of the print image 80 to which the mask 85 is applied is expressed by RGB values, the control unit 4 converts the color information of the print image 80 to which the mask 85 is applied into CMYK values by executing a color conversion process (S280).

Next, the control unit 4 executes a halftone process (S290) to generate dot data based on the print image 80 to which the mask 85 is applied.

Then, the control unit 4 executes a rasterization process (S300) for generating dot data for each pass based on the dot data generated in step S290. At this time, the control unit 4 generates dot data for each pass so that pigment ink is ejected a plurality of times to the same position on the medium S. This makes it possible to recover color development of the gloss designation region 81a, which has been reduced due to the presence of the large number of non-ejection regions b, to a certain degree.

For example, when pigment ink is ejected once to the same position in a standard print mode, pigment ink may be ejected twice to the same position in the glossy print mode. For example, when pigment ink is ejected four times to the same position in the standard print mode, pigment ink may be ejected eight times to the same position in the glossy print mode.

The control unit 4 changes the number of times of ejecting pigment ink to the same position according to which of print speed and color development acquired in step S230 is prioritized. That is, as the number of times of ejecting pigment ink to the same position increases, the transport amount of the medium S between passes also decreases, and thus print speed inevitably decreases. Therefore, as an example, the control unit 4 sets the number of times of ejecting pigment ink to the same position to four times when print speed is set to be prioritized over color development in step S230, and sets the number of times of ejecting pigment ink to the same position to eight times when the color development is set to be prioritized over print speed in step S230. The number of times of ejection when print speed is prioritized is a specific example of a first number of times. The number of times of ejection when color development is prioritized is a specific example of a second number of times. The first number of times is set to be smaller than the second number of times.

As described above, when an overlapping printing is performed in which ink is ejected to the same position a plurality of times, color development of the gloss non-designation region 81b may become excessive. However, since color development of the gloss non-designation region 81b is intentionally reduced in step S270, the result is that the increase in color development of the gloss non-designation region 81b due to overlapping printing and the decrease due to the input level adjustment are offset with respect to color development of the gloss non-designation region 81b.

Finally, the control unit 4 executes inkjet printing based on the dot data for each pass generated in step S300 (S310), forms the print image 80 on the medium S, and then ends the process.

When the ink jet printing is executed, it is arbitrary whether or not overcoat liquid is applied to the medium S. However, when overcoat liquid is applied to the medium S having glossiness, color of glossiness of the medium S becomes slightly darker.

Therefore, when the glossy print mode is executed, it is conceivable to omit application of overcoat liquid.

The preferred embodiments of the present disclosure have been described above. The above-described embodiment has the following features.

The printing device 1 includes the head unit U (print head unit) including the nozzle array M (nozzle group) of the plurality of nozzles N configured to eject liquid onto the medium S and the control unit 4 (control section) that forms an image on the medium S by controlling an ejection operation of the head unit U. When the medium S is a fabric having glossiness and having an indentations-protrusions shape in which fibers in different directions intersect each other and liquid is pigment ink containing a pigment as a coloring material, the control unit 4 alternately arranges the ejection region a in which liquid is ejected and the non-ejection region b in which liquid is not ejected in the gloss designation region 81a that is a region designated to leave glossiness in the print image 80 (input image). According to the above-described configuration, in the gloss designation region 81a, it is possible to secure color development without impairing glossiness.

In the above-described embodiment, the gloss designation region 81a is a part of the print image 80, but instead of this, the entire print image 80 may be the gloss designation region 81a.

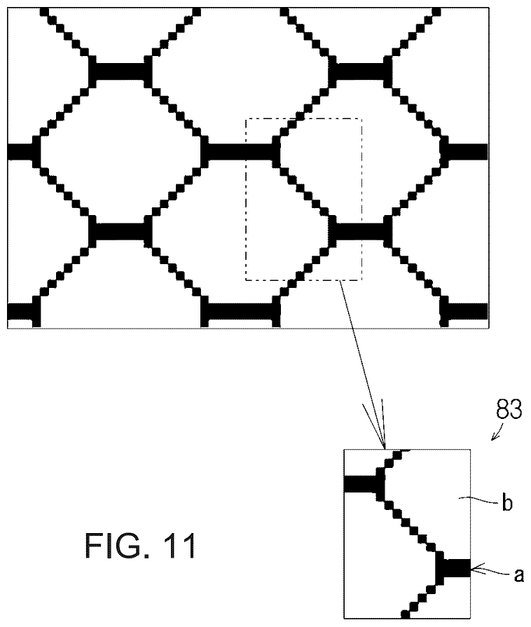

In the present specification, “alternately arranging the ejection region a in which liquid is ejected and the non-ejection region b in which liquid is not ejected” is not limited to alternately arranging the ejection region a and the non-ejection region b such that the appearance ratio of the ejection region a and the non-ejection region b is 1:1 in the vertical direction and the horizontal direction of the paper surface as in the tile 83c and the tile 83d shown in FIG. 8. For example, a case where the ejection region a and the non-ejection region b are alternately arranged such that the appearance ratio of the ejection region a and the non-ejection region b is 1:2 or 2:1 in the vertical direction and the horizontal direction of the paper surface as in the tile 83a, the tile 83b, the tile 83e, and the tile 83f shown in FIG. 8, a case where the ejection region a and the non-ejection region b are alternately arranged such that the appearance ratio of the ejection region a and the non-ejection region b is 1:9 in the vertical direction of the paper surface and 1:4 in the horizontal direction of the paper surface as in the tile 83 shown in FIG. 11, and a case where the ejection region a and the non-ejection region b are alternately arranged at any other appearance ratio can be included.

In addition, when the glossy print mode is executed, the control unit 4 generates dot data so as to eject liquid a plurality of times to the same position (S300). According to the above-described configuration, color development in the gloss designation region 81a is improved, so that the decrease in color development caused by the presence of the non-ejection region b can be compensated for.

The control unit 4 can select either the first number of times or the second number of times different from the first number of times as the number of times of ejecting liquid to the same position. According to the above-described configuration, for example, in a case where print speed is prioritized over color development, the print speed can be increased by selecting the smaller number of times of the first number of times and the second number of times, and in a case where color development is prioritized over print speed, the color development can be increased by selecting the larger number of times of the first number of times and the second number of times. In this manner, since the number of times of ejecting liquid to the same position can be changed according to which of color development and print speed is prioritized, the printing device 1 capable of flexibly responding to a request of a user is realized. The number of times of ejecting liquid to the same dot is also referred to as the number of times of overlapping ejection.

When the glossy print mode is executed, the control unit 4 lowers the input level of the gloss non-designation region 81b, which is a region of the print image 80 excluding the gloss designation region 81a. According to the above-described configuration, color development in the gloss designation region 81a and color development in the gloss non-designation region 81b can be made close to each other.

When the glossy print mode is executed, the control unit 4 alternately arranges the ejection region a and the non-ejection region b in the vertical direction (first direction) and the horizontal direction (second direction) orthogonal to the vertical direction in the gloss designation region 81a. According to the above-described configuration, it is possible to exhibit a visual effect specific to a glossy print mode even when a print product is observed from any direction.

The outer dimension of the non-ejection region b is set to be equal to or larger than a predetermined outer dimension in a print product. That is, in visually recognizing the surface characteristics of the medium S, when the area where the medium S is exposed is excessively small, pigment ink is formed in a raised shape on the medium S, and thus the angle of incidence (angle of reflection) of light for exhibiting gloss is inevitably small. Therefore, the angle at which gloss can be visually recognized is limited. In an extreme case, glossiness is felt only when the medium S is observed from the normal direction. In contrast, when the outer dimension of the non-ejection region b is equal to or larger than the predetermined outer dimension, even the medium S on which the print image 80 is recorded can be visually recognized with a certain degree of gloss.

When the glossy print mode is executed, the control unit 4 can select any one of a first area ratio and a second area ratio different from the first area ratio as an area ratio of the ejection region a and the non-ejection region b. See the tile 83a, the tile 83c, the tile 83e in FIG. 8. According to the above-described configuration, for example, in a case where glossiness is prioritized over color development, glossiness can be increased by selecting the tile 83a, and in a case where color development is prioritized over glossiness, color development can be increased by selecting the tile 83e. In this way, since the area ratio of the ejection region a and the non-ejection region b can be changed according to which of color development and glossiness is prioritized, the printing device 1 that can flexibly respond to a user's request is realized. The area ratio of the ejection region a and the non-ejection region b may be replaced with a coverage rate that is an area ratio of the ejection region a in the tile 83.

When the glossy print mode is executed, the control unit 4 realizes the ejection region a and the non-ejection region b in the gloss designation region 81a by performing the masking process on the print image 80. According to the above-described configuration, the glossy print mode can be executed by simple image process.

In the above-described embodiment, the print image 80 is thinned out in a print product by executing the masking process on the print image 80, thereby ensuring glossiness. However, instead of this, glossiness may be secured by thinning out the print image 80 in a print product by executing the masking process on dot data for each pass. That is, the masking process may be executed at any stage as long as the print image 80 is thinned out in a print product.

As shown in FIG. 9, a region corresponding to the gloss designation region 81a in the mask 85 is a tiling pattern in which the single tiles 83 are repeatedly laid in a predetermined direction. According to the above-described configuration, it is possible to uniformly realize a visual effect of leaving glossiness in the gloss designation region 81a.

The above-described embodiment may be modified as follows.

That is, in the above-described embodiment, the tile 83 used for the masking process is selected from the plurality of types of tiles 83 shown in FIG. 8 based on which of glossiness and color development acquired in step S220 is prioritized. However, when the control unit 4 executes the glossy print mode, it is not necessary to consider which of glossiness and color development is prioritized. In this case, the control unit 4 selects one of the tile 83c and the tile 83d from among the plurality of types of tiles 83 shown in FIG. 8 according to the output resolution of the print image 80.

Similarly, in the above-described embodiment, the number of times of ejection of pigment ink to the same dot is increased or decreased in the rasterization process of the step S300 based on which of print speed and color development acquired in the step S230 is prioritized. However, when the control unit 4 executes the glossy print mode, it is not necessary to consider which of print speed and color development is prioritized. In this case, the control unit 4 maintains the number of times of ejection of pigment ink for the same dot at the predetermined number of times of ejection.

Similarly, in the above-described embodiment, the mask is applied in step S260, and then the halftone process of step S290 is executed. However, a step of applying the mask may be performed after the halftone process is performed. In this case, there is no possibility of ejection by the halftone process, for example, onto a region designated as a non-ejection region by the mask, and it is possible to reliably avoid ejection onto the region designated as the non-ejection region by the mask.

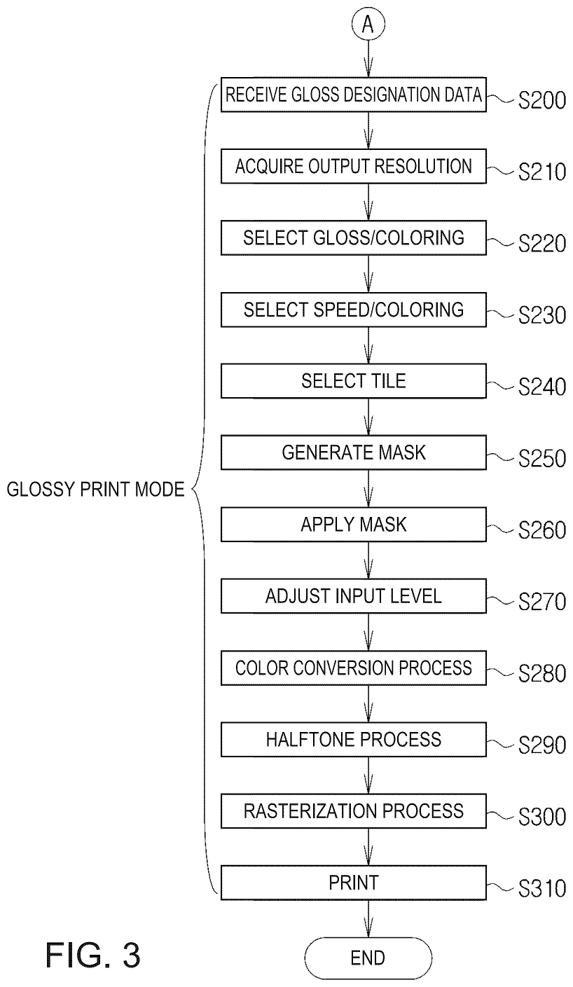

Note that, in a case where the mask is applied after the halftone process, a process of applying the mask by the number of colors for which the halftone process is executed occurs, and thus, the process can be simplified by executing the halftone process after applying the mask as shown in FIG. 3. Therefore, the order in which the processes are executed may be changed as appropriate.

It is known that a mask is applied in a halftone process, but it is needless to say that the important thing in the present disclosure is to apply a mask in a process different from the halftone process.

In the above-described embodiment, the mask 85 has the same size as the print image 80 and the gloss designation image 81. However, instead of this, the mask 85 may have the same size as the gloss designation region 81a in the gloss designation image 81. In this case, the mask 85 is applied only to the region corresponding to the gloss designation region 81a of the gloss designation image 81 in the print image 80.

As described above, when the glossy print mode is executed, the control unit 4 realizes the ejection region a and the non-ejection region b in the gloss designation region 81a by the masking process on the print image 80. However, the ejection region a and the non-ejection region b in the gloss designation region 81a may be realized by other data process instead of this. For example, the ejection region a and the non-ejection region b in the gloss designation region 81a may be realized by storing two-dimensional image data of the print image 80 in a one-dimensional array, converting color information of elements having the remainder of 2, 3, or 4 when array index is divided by 7 in the one-dimensional array into white or a completely transparent color, and converting the one-dimensional array after the conversion into two-dimensional image data.

FIG. 11 shows a modification of the tile 83. As shown in FIG. 11, the non-ejection region b may be a lattice pattern having a rhombus shape. In the tile 83 shown in FIG. 11, the area ratio of the ejection region a and the non-ejection region b is 1:9. That is, the coverage rate, which is the ratio of the ejection region a in the tile 83, is 10%. In the tile 83 shown in FIG. 11, the ejection regions a and the non-ejection regions b are alternately arranged so that the appearance ratio of the ejection regions a and the non-ejection regions b is 1:9 in the vertical direction of the paper surface and 1:4 in the horizontal direction of the paper surface.

In the above-described example, the program can be stored and supplied to a computer using various types of a non-transitory computer readable medium. The non-transitory computer readable medium includes various types of tangible storage medium. Examples of the non-transitory computer readable medium include a magnetic recording medium (for example, a flexible disk, a magnetic tape, and a hard disk drive) and a magneto-optical recording medium (for example, a magneto-optical disk). Examples of the non-transitory computer readable medium further include a CD-ROM (read only memory), a CD-R, a CD-R/W, a semiconductor memory (for example, a mask ROM), and the like. Examples of non-transitory computer readable medium also include a programmable ROM (PROM), erasable PROM (EPROM), flash ROM, and a random access memory (RAM). The program may be supplied to a computer by various types of a transitory computer readable medium. Examples of the transitory computer readable medium include electric signals, optical signals, and electromagnetic waves. The transitory computer readable medium can supply the program to a computer via a wired communication path such as an electric wire and an optical fiber, or a wireless communication path.

What is claimed is:

1. A printing device comprising:
a print head unit including a nozzle group of a plurality of nozzles configured to eject liquid onto a medium and
a control section that forms an image on the medium by controlling an ejection operation of the print head unit, wherein
the control section is configured to execute a first print mode in which, when the medium is a fabric having glossiness and having an indentations-protrusions shape in which fibers in different directions intersect each other, and the liquid is pigment ink containing a pigment as a coloring material, an ejection region in which the liquid is ejected and a non-ejection region in which the liquid is not ejected are arranged in a gloss designation region that is a region of an input image that designated to leave glossiness.

2. The printing device according to claim 1, wherein
when the first print mode is executed, the control section generates dot data so as to eject the liquid a plurality of times to a same position.

3. The printing device according to claim 2, wherein
the control section is configured to select, as a number of times to eject the liquid to a same position, either a first number of times or a second number of times different from the first number of times.

4. The printing device according to claim 1, wherein
when the first print mode is executed, the control section lowers an input level of a gloss non-designation region that is a region of the input image excluding the gloss designation region.

5. The printing device according to claim 1, wherein
when the first print mode is executed, the control section arranges, in the gloss designation region, the ejection region and the non-ejection region alternately in a first direction and in a second direction orthogonal to the first direction.

6. The printing device according to claim 1, wherein
an outer dimension of the non-ejection region is set to be equal to or larger than a predetermined outer dimension in a print product.

7. The printing device according to claim 1, wherein
when the first print mode is executed, the control section is configured to select either a first area ratio or a second area ratio different from the first area ratio as an area ratio of the ejection region to the non-ejection region.

8. The printing device according to claim 1, wherein
when the first print mode is executed, the control section realizes the ejection region and the non-ejection region in the gloss designation region by performing a masking process on the input image.

9. The printing device according to claim 8, wherein
in a mask used in the masking process, a region corresponding to the gloss designation region is a tiling pattern in which single tiles are laid.

10. The printing device according to claim 8, wherein
a mask applied to the gloss designation region is a lattice pattern.

11. The printing device according to claim 1, wherein
the fabric having glossiness means that reflection characteristics of light change depending on an angle at which the fabric is observed.

12. The printing device according to claim 1, wherein
the fabric having glossiness is a fabric woven with chemical fibers.

13. The printing device according to claim 1, wherein
the fabric having glossiness is a fabric woven by twill weave or satin weave.

14. A printing method of forming an image on a medium by controlling an ejection operation of a print head unit including a nozzle group of a plurality of nozzles configured to eject liquid onto the medium, the printing method comprising:
executing a first print mode, by a computer, in which, when the medium is a fabric having glossiness and having an indentations-protrusions shape in which fibers in different directions intersect each other, and the liquid is pigment ink containing a pigment as a coloring material, an ejection region in which the liquid is ejected and a non-ejection region in which the liquid is not ejected are arranged alternately in a gloss designation region that is a region of an input image that designated to leave glossiness.
